(19) United States
(12) Patent Application Publication
(10) Pub. No.: US 2007/0067098 A1
(43) Pub. Date: Mar. 22, 2007

(54) Method and system for identification of geographic location

(76) Inventor: Oleg U. Zelentsov, Moscow (RU)

Correspondence Address: DONN K. HARMS;PATENT & TRADEMARK LAW CENTER, SUITE 100, 12702 VIA CORTINA, DEL MAR, CA, 92014, US

(21) Appl. No.: 11/230,357

(22) Filed: Sep. 19, 2005

(51) Int. Cl. G01C 21/32

(52) U.S. Cl. 701/208

(57) ABSTRACT

A device and method for creating user-specific geographic profiles which are stored on a database and are retrievable based on the communication of a user-specific designator relating to each respective geographic profile. Third parties to whom the user communicates his individual designator may access the geographic profile from the database to enable them to deliver or otherwise provide products or services to the geographic location of the user based on the information in the individual designator. The individual designators may be transmitted directly from the user to third parties or may be printed in directories or advertisements to allow third parties to find the user. Temporary designators may be automatically created on the database without manual input by the user when GPS enabled cell phones or similar devices communicate the user's temporary location to the server.

### FIELD OF THE INVENTION

The invention herein disclosed and described relates to a system for electronic designation and identification of locations geographically. More particularly it relates to a standardized system and method for creation, storage, and broadcasting and employment of geographical location data regarding specific geographic locations. The electronic information identifying specific geographic locations is generated by data input via electronic means such as over the Internet or other means for electronic transmission to a receiving point. Resulting data, universally identifying the specific geographic point on the earth by address or substantially specific location, and optionally other contact information, is distributable via electronic means to third parties over the internet, via GPS devices or any other electronic devices, or via satellite or terrestrial electronic transmissions, or via distributed electronic storage media used by computers and portable computing devices for lookup of data and display or communication of the location in question. The communicated location and contact data can be converted to any existing geographical data exchange formats. The unified information format can also be employed to save results of searches of online or offline digital maps in unified form and ability to transfer or distribute these results to a plurality of databases, for example, to Dunn and Bradstreet, and to an infinite number of communication devices and third parties.

### BACKGROUND OF THE INVENTION

Communication of location information for individuals and businesses to third parties has been a vexing problem since the dawn of travel. For decades prior to the Internet, directions were generally communicated in writing through the transmission of an address or locale description from the conveying party to the traveling party of the physical address or position of the location to be visited by the traveling party. The communication of the address or locale enabled the traveling party to locate the destination on a map and to plot a travel plan to get to the desired geographic point.

With the advent of the Internet and the Global Positioning System of Satellites (GPS), communication of directions for travel or delivery to a designated point by the conveying party to the traveler has been simplified through the use of computing devices. In conveying a location or address on the Internet, the conveying party frequently refers a request for directions from the traveling party to a proprietary website such as Mapquest, through a link that takes the traveling party to a webpage showing the desired destination of the conveying party. Other commercial services provide maps and directions which are transmitted to PDA's and cell phones via satellite or terrestrial communications. Such services all generally use a basic electronic map databases. Further, such services and systems generally require the inquiring party to actively seek and search for a desired address information.

To date, there is no common denominator for the formation, request, storage, or transmittal of geographic location information which can be initiated by either a customer, a shipper, a supplier, or a traveler to direct them to a desired destination. There is no system or method for a customer to easily designate a delivery address that may be used by all parties in the supply chain interchangeably. The result is a plethora of different operating systems, data configurations and types of data transmission, all of which are not interchangeable, and all of which require the party desiring the geographic information to search it on one of a plurality of databases and a multitude of systems.

Such an antiquated system lacking in standards fails to provide an easily accessed and employed method and apparatus to communicate a location to a potential visitor or delivery service. Additionally, such a lack of standards requires the repetitive input and retrieval of directions and maps to a specific geographic point and the printing of or converting of data from one format to another. This antiquated system of directions and determining locales should not exist in the digital age.

One example occurs daily when a customer orders products for delivery. Unless the seller is a regular provider to the individual customer, which is generally not the case, the customer is required to tediously enter address information for the delivery. This data yields text that describes the delivery address.

Subsequently, the seller must take the text address information and either manually or electronically, through multiple different types of database searches, determine the exact geographic location for the delivery of the order. The seller then can determine how to ship the order and on what carrier prior to printing an address label with the text information originally input by the customer. In a next step, the text geographic information provided by the customer must then be relayed to the delivery service who again must use the text information to determine the exact streets and routes to the delivery point.

Such a tedious process occurs billions of times a day where customers order products from sellers who either deliver themselves or ship the products through a third party delivery service. Customers are thus forced to repeatedly input shipping data to each new vendor. Sellers are required to use the data for their own determination of the proper freight carrier for the delivery. The freight carriers use the same address information in their own determination of delivery routes and locations.

Another excellent example of the needlessly repetitive process of determining a destination point occurs for parties such as weddings or birthdays. In such cases, invitations are sent to the guests for the event. The guests, if they do not know the party destination from memory, must tediously look up the address for the party on a printed map or perhaps through an online mapping service. Then the guests can determine the route to the destination. Consequently, party guests and business and leisure travelers are forced to continue to look up destinations through the tedious process of reviewing maps or searching map websites.

A third example of tedious duplication of effort in determining locations is that of a pedestrian ordering a taxi at a mobile location. The pedestrian must telephone the taxi provider and tell them orally their location so the taxi may come to pick them up. The operator at the taxi firm must type the oral instructions from the pedestrian into a computer for either electronic transmission to the taxi drivers or transmission orally by radio. The taxi driver must take the information about the location and look up the address in a map book if the driver does not have it committed to memory. Here again, multiple inputs of the same information and non-standard methods of communicating specific locations cause duplication of effort, errors, and slower service.

As such, there exists an unmet need for a universal method and system for determining and communicating geographic locations. Such a system should be simple and easily implemented in a standard data format and procedure format which can be employed across different software platforms and amongst different electronic devices. Such a system should eliminate the tedious and duplicate intermediate steps where a seller or other party with a point of destination must continuously enter address and destination information which must be then communicated to third parties who must also research that information using maps or databases. Such a system should provide an easy means for geographic point identification that can be readily used by any third party to immediately determine the geographic delivery or destination point in question without the input of specific data by the customer or providers of that information. Still further such a system should be universally employable on computers, PDA's, GPS units, cell phones, and other data processing communication devices to determine and communicate to the user the destination or location based solely on an input identifier without the need for the user to contact the source of the identifier for contact or destination information.

With respect to the above description, before explaining at least one preferred embodiment of the invention in detail, it is to be understood that the invention is not limited in its application to the details of construction and to the arrangement of the components and/or steps set forth in the following description or illustrated in the drawings. The various apparatus and methods and steps of implementation of the invention herein described and disclosed are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other devices, methods and systems for carrying out the several purposes of the present disclosed device. It is important, therefore, that the objects and claims be regarded as including such equivalent construction and methodology insofar as they do not depart from the spirit and scope of the present invention.

Further objectives of this invention will be brought out in the following part of the specification, wherein detailed description is for the purpose of fully disclosing the invention without placing limitations thereon.

### SUMMARY OF THE INVENTION

The present invention satisfies the above unmet needs and overcomes the above-stated and other deficiencies of the prior art by providing a standard system and method for creation for geographic location determination that may be used by all parties who must determine an ultimate address for a delivery, meeting, or other reason. The system and method herein disclosed and described provides an easy and universally deployable system for identification of an address or geographic location of an identifying party, to one or a plurality of other responding parties needing the information on the geographic location of the identifying party. It allows the customer or traveler or pedestrian or event planner or other identifying party, to simply create and provide a universal common designator, which contains a user-specific geographic profile for their specific locale, which third parties may employ to determine or find the designated location. Once created, the user-specific designator may be provided by the customer or traveler or other identifying party to merchants, guests, potential customers, and other responding third parties, without having to enter, recite, or write their location or contact information. The designator allows third parties to access the geographic profile relating to the designator from a remote database holding the information. This can be done without any input from the user who created the specific geographic profile, thereby eliminating repetitive entry of location information.

The system herein described provides a common means for specific designation of the individual geographic point or address and/or contact information of the identifying party in the form of a designator which currently, for description purposes, is called a designator or an eMark. This common identification designator, once issued, can be saved locally on a computer or other type of data storage device, or preferably can be stored on a central database or data storage device that is accessible by third parties who have the designator.

The eMark, once created, can be transferred to a GPS enabled device having a look-up table of such designators or the ability to access the common database storing such designators for the information about the identifying party and can be integrated into displayed maps and oral directions. The common identification designator can be e-mailed to third parties to communicate the geographic and other contact information about the identifying party, whereafter such third parties can access the common database or local lookup tables holding such designators and the standardized information relating to the individual eMark or designator to determine the contact information of the identifying party.

Because the designators are user-specific and relate directly to data in a user geographic profile stored in a universally readable format and specific to the identifying user supplying the designator to third parties, the information therein can be used with online or offline digital maps to determine destinations and map points. Further, the designators can be published in online directories or printed telephone directories or advertisements, giving third parties geographic contact information about the listed parties in the directory. There is an infinite number of purposes for which the eMarks or designators can be employed since all parties would be able to download the standardized data regarding location and/or identity and personal information of an individual eMark designator. Because the geographic profile data regarding the individual designators will be in a universally known and uniform format, it can easily be converted to any existing geographical data exchange format, for use in an infinite number of maps, electronic devices, and computing and communication devices.

In use, the eMark or otherwise named individual designators are initially generated by the person or business wishing to provide geographical and optionally personal or other contact information. This is done by communicating with software adapted to the purpose of accepting the geographic profile information from a user, storing it on a server or database and issuing the eMark designation to the user. There can be varying degrees of distribution of the information related to each individual identifying designator or eMark. The party originating the creation of the eMark would determine when it is used or communicated to another party and therefore who accesses the data relating to that individual eMark designator.

For maximum security, one type of individual designator can be at the option of the identifying commercial or private party digitally signed. These confidential individual designators would be intended for commercial use and would provide maximum security as to the contained information, yet would still be easily and safely distributed. Lesser security would be provided by registered individual designators which would be intended for commercial use, where less security as to the contained information is desired.

As an example, the designator or eMark owner in ordering a product would provide his confidential individual user-specific designator to the vendor. The vendor, possessing the eMark identification, would be authorized to access a central database of the geographic profile related to each eMark for the information as to location of the eMark provider or identifying party and/or contact information. The user who provides his eMark or other named designator in purchasing a product or service is thereby relieved of entering names, addresses, etc. and would not have to send such personal information across the internet or over the telephone to unknown parties. Instead, he would provide his confidential individual designator, or eMark, and the vendor would then have authorization to access all needed information to complete the order, pay for it and ship it.

Most importantly the vendor and its freight carriers would have access to a standardized means to geographically identify the point of delivery or provision of service for all parties who provide their eMark. The supplier or seller would no longer need to provide address or delivery information, but would need only to provide the eMark of the buyer. The carrier or delivering party no longer would need to cross-reference typewritten or other indicia relating to location since the eMark would already specifically identify the location, and the carrier would have access to the information relating to each eMark for each order.

In the case of changing or portable destinations, such as a taxi ride request, another preferred mode of the device would create temporary eMarks that would be automatically deleted once the service is provided. In this case a buyer needing a service would use his cell phone to telephone the seller. During the order a temporary eMark would be generated. This can be done using the GPS co-ordinates, or cellular tower triangulation or other means for determining the temporary location, and subsequent parties like taxi drivers would be transmitted the eMark for the person wanting a ride. The driver would be able to determine the destination and best route to the party with the temporary eMark, using their computerized device to access the eMark database which would provide cross-referenced map directions. In high traffic areas such as cities, driving directions to the temporary eMark might also be returned to the driver requesting the information. Those driving directions can take into consideration the current traffic information which is generally available in most cities online.

The broadest scope of accessible information would be provided by openly universally accessible individual designators or eMarks. The specific geographic location and contact data associated with each individual eMark, or otherwise designated unrestricted individual designator, would be stored on a central database. That data would be accessible by any authorized party who is provided an individual's designator for an order, directions, or other purpose. The data transmitted subsequent to an eMark inquiry of the data base will provide the inquirer the specific geographic location of the eMark holder and other data associated with that specific eMark. Of course the system would be multi-lingual since the locations provided are on local maps in local countries. While English is envisioned as a primary language of communication, the system will work in any language. In fact, because the system provides specific eMark information about the eMark holder based on maps, not language, the system is by its very nature universal in language. This would of course be most helpful to travelers who do not know the area of their locale and need a taxi, or, for instance, restaurants giving their eMark to a tourist who is then given map points in their own language. The system can easily determine if different languages are spoken by the eMark holder and the other party and can adjust by giving both directions in their native language.

A good example of the use of such open individual designators would be when an identifying party is ordering a product from a vendor. Instead of providing the usual tedious input of name and address and contact information, the identifying party would complete the products they wished to order and at the end of the order would simply provide their eMark or individual designator. The vendor would then take that designator, and by having the designator number or other alphanumeric code associated with that individual eMark, would be able to access a central database or stored local database and look up all required information for shipment and/or contact of the party providing the eMark.

Other types of eMark, or individual designators can also be provided for different specific uses. For instance, Private Registered individual designators can be created for personal use and internal use in a company or organization. These would provide location information to those parties inside the organization to which the individual designators are limited for use. Individual designators for cell phone use can also be created. Or, temporary eMark or individual designators might also be created for one time events or persons or organizations only needing to provide location and/or contact information for a finite period of time. Finally, encrypted eMark or individual designators could be created for the utmost security. Such encrypted individual designators would require a public or private key to de-encrypt the eMark and then access the information from a centrally accessible database once the eMark is provided by the identifying party to another party.

As a general method for all individual identifiers which are herein referred to as eMark, a number of common steps are taken by the identifying party to generate their eMark.

This would include the steps of:

a) establishing an issuer of individual user-specific designators for related geographic profiles;

b) having a user communicate with the issuer of the individual identifier and requesting a user-specific designator;

c) having the user input personal data to the geographic profile, identifying the holder of the eMark, including one or a combination of location contact information including a person's name, a company name and a postal address, a physical address or geographic location description.

d) issuing the individual designator to the user;

e) from the input personal data, storing the location contact information in a geographic profile using standardized data format on a database referenceable primarily through input of an individual identifier;

f) providing access to the database to inquiring parties to whom the individual designators have been communicated; and

g) providing respective location contact information in a common format from the user specific geographic profile to the inquiring parties which relates to the individual identifier communicated by the inquiring parties.

Optionally, the method can also provide one or a combination of the steps of:

h) allowing the user to input means for personal contact to be included in the location contact information through allowing input of one or a combination of telephone numbers, e-mail addresses, or webpage addresses;

i) allowing the user to input varying levels of access to the location contact information or other information in the geographic profile to restrict access to their respective location contact information on the database only to authorized third parties;

j) having the issuer of the user specific designator cross-referenced to the user's address or geographic location as input, to longitude and latitude or other map coordinates or map points which are provided in the location contact information to inquiring parties for use with mapping or GPS devices to identify the user's location.

k) having the issuer check validity of submitted location contact information in the geographic profile before assigning the user specific designator to the user;

l) translating information transmitted to each respective party to their native language based on input information from that party.

m) digitally signing the designator at the option of the identifying commercial or private party.

Once a user has accomplished the input of the location contact information and has been issued the user specific designator by the issuer, the user can thereafter simply provide the designator or eMark to any and all parties in need of location information for the user. With the optional input, the issued individual identifier will also provide personal contact information and geographic map coordinates along with the rest of the data provided in common format in the location information transmitted to inquiring parties.

With respect to the above description then, it is to be realized that the optimum operational relationships for the various steps in the method of operation of the invention to include variations in order, data presentation, and input can be employed and are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact operation shown and described, and accordingly, all suitable modifications and equivalents may be resorted to, falling within the scope of the invention.

In this respect, before explaining at least one embodiment of the invention in detail it is to be understood that the invention is not limited in its application to the details and to the arrangement of the method and steps set forth in the following description or illustrated in the drawings. The invention is capable of other embodiments and of being practiced and carried out in various ways. Also, it is to be understood that the phraseology and terminology employed herein are for the purpose of description and should not be regarded as limiting.

It is an object of the present invention to provide an individual identifier or user specific designator to users, which when communicated by the user, will inform the receiving party of location information containing the address and/or geographic location of the user.

It is a further object of this invention to provide an accessible database of respective individual user-specific geographic profiles, each of which is associated with a user-specific designator which can be communicated to any party having the user-specific designator.

It is yet an additional object of this invention to provide such a system for provision of location information that optionally allows the user to provide personal contact information to be included in the communicated individual location information.

Yet another object of this invention is the provision of such a system for provision of location information related to individual user-specific designators which may provide varying levels of access to each location information file depending on the authorization of the inquiring party.

A further object of this invention is the provision of such a system for providing geographic profiles related to each user specific designator, which additionally includes electronic map coordinates for the address or geographic location of the owner of the user-specific designator, such that the map coordinates may be used with GPS or other electronic mapping and display devices.

Yet another object of this invention is the provision of the information contained in each geographic profile in a standardized format that may be adapted across any software operating system or program to allow third parties to employ the location information file for customized purposes.

A still further object of the disclosed invention is the standardization of “how to find me” information that is communicated by users to third parties in need of location or address information on the user.

Yet a further object of this invention is the creation of a universal geographic identifier related to a specific user that may be employed in print, orally, in ads, directories, or other means, to communicate a specific, user-specific, geographic location to a third party.

The foregoing has outlined some of the more pertinent objects of the invention. These objects should be construed to be merely illustrative of some of the more prominent features and applications of the intended invention. Many other beneficial results can be attained by applying the disclosed invention in a different manner or by modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings wherein the detailed description is for the purpose of fully disclosing the invention without placing limitations thereon.

### BRIEF DESCRIPTION OF THE FIGURES

FIG. 1 depicts a flow chart showing the creation and distribution of user-specific designators, currently known as an eMark, which are issued to users and which directly correlate to centrally accessible or distributed location geographic profile information files relating to each individual identifier.

FIG. 2 depicts a typical formation and use of a temporary eMark which may be employed to identify a geographic location to third parties.

### DETAILED DESCRIPTION OF THE PREFERRED EMBODIMENTS OF THE INVENTION

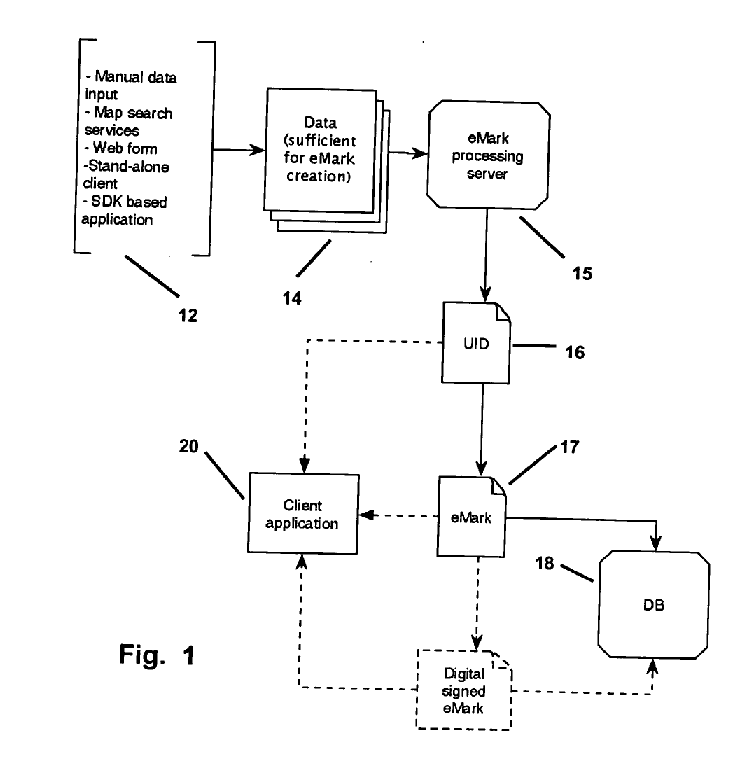

Referring now to the drawings, FIG. 1 depicts a flow chart showing the creation and distribution of user-specific designators, currently called eMarks, which relate to centrally accessible or distributed user-specific geographic profiles relating to each individual designator.

The base method and optional activities herein disclosed are shown in FIG. 1. As shown, the method and system create a universally accessible eMark or individual, user-specific designators, for each user who provides the information necessary to be stored in a user specific geographic provile on a file server. In use, in assigning the user specific eMark, the server or other database managing component or software, would first request manual data input 12 from a user. Such a step would employ software having fields to be completed which would allow the user to input the required and optional information to create the individual eMark or user specific designator that would relate only to that individual user.

In the first step, with an established issuer of the eMark running the appropriate software on a computer with memory and engaged to a server, a user would input data 12, or otherwise communicate to the issuer of the eMark or individual designator, and thereby initiate the system to request issuance of a user-specific designator. Software on the computer or server would display input screens having the appropriate fields for the user to provide input personal data identifying the identity and location contact information in a geographic profile of the user requesting the designator. The location contact information in the geographic profile will include one or a combination of elements of location contact information including a person's name, a company name and a postal address, a physical address or geographic location description. At a minimum, it would include sufficient information to determine an address or geographic point on the earth relating to that user and the issued user-specific designator for that user.

While optional in the preferred mode, in a next step software on the issuing computer or server would check the data entered by the user for validity 14 and to determine if the data is substantially error free and valid, under review criteria set by the issuer to create a user specific geographic profile or universal identification (UID) file 16 that contains the data input and checked. At a minimum, the geographic profile or UID 16 would contain geographic location information, such as an address, or point of location on a map, or other means to identify the user's location, which is specific to the user being issued the eMark generated.

If the information in the created UID 16 file is determined sufficiently error free and meets the minimum criteria of the issuer, an individual designator 17 is issued to the requesting user 16 and related on the database 18 ccesible by the server, to their specific individual geographic profile. The server 15 or computing device, using software and any hardware required for the task also would form and store a geographic profile on the database 18 containing the input personal data 12 provided by the requesting user. The input data 12 stored in the geographic profile specific to the user to whom the individual designator 17 was issued, on the database 18, will be in a standardized format and specifically related to its respective user-specific designator 17 or eMark.

This database 18 would then be accessible to authorized inquiring parties to whom the user-specific designator is communicated by a user. Once a proper individual designator 17 is communicated by a third party who has received it from a user or print ad or otherwise, the server 15 would provide that third party 19 the respective user-specific geographic profile, in a common format to the inquiring party, which specifically relates to the individual designator communicated by the inquiring party. The inquiring party would then have the specific geographic contact information from the geographic profile related to the input designator 17 to visit, ship to, pick up, or otherwise contact the user who provided their user-specific designator 17, without the need for the user to input that information to the third party or multiple third parties. The information in a scandalized open source format would allow the third party 19 to employ client applications 20 such as mapping programs, routing programs, or other software, to locate the user's geographic location provided by the data input 12 and use it as required.

Optionally, the method can also provide one or a combination of the steps of:

a) allowing the user to input means for personal contact to be included in the geographic profile through allowing input of one or a combination of telephone numbers, email addresses, or webpage addresses;

b) digitally signing the designator at the option of the identifying commercial or private party;

c) allowing the user to input varying levels of access to the location contact information to restrict access to their respective location contact information in their geographic profile, or encrypting it, thereby allowing access to the data input only to authorized third parties having an appropriate public or private key;

d) having the issuer of the user-specific designator cross reference the user's address or geographic location as input, to longitude and latitude or other map coordinates or map points, which are provided in the location contact information from the geographic profile to inquiring parties for use with mapping or GPS devices or other client applications 20, to identify the user's location visually on a map. The client applications 20 may also use the location information to determine the best route to the user location and might even cross reference the location with traffic reports in that determination.

Once a user has accomplished the input 12 of the location contact information for their geographic profile and been issued the individual designator 17 by the issuer, the user can thereafter simply provide the individual designator 17 to any and all parties in need of location information for the user. Those third parties may employ the information from the geographic profile elicited from the server in response to submission of the individual designator 17 to ship to or visit the user's address or geographic location. With the optional input, the issued individual designator will also provide personal contact information and varying levels of other information depending on the authorization of the third party.

Once created, the individual designator 17 may be communicated to third parties 19 in a variety of fashions for an infinite number of reasons including but not limited to ordering products, requesting services at the user's location, providing a location to guests at a party, providing location information to attendees of a meeting or a convention, and any other reason that a user would need to notify third parties of a location.

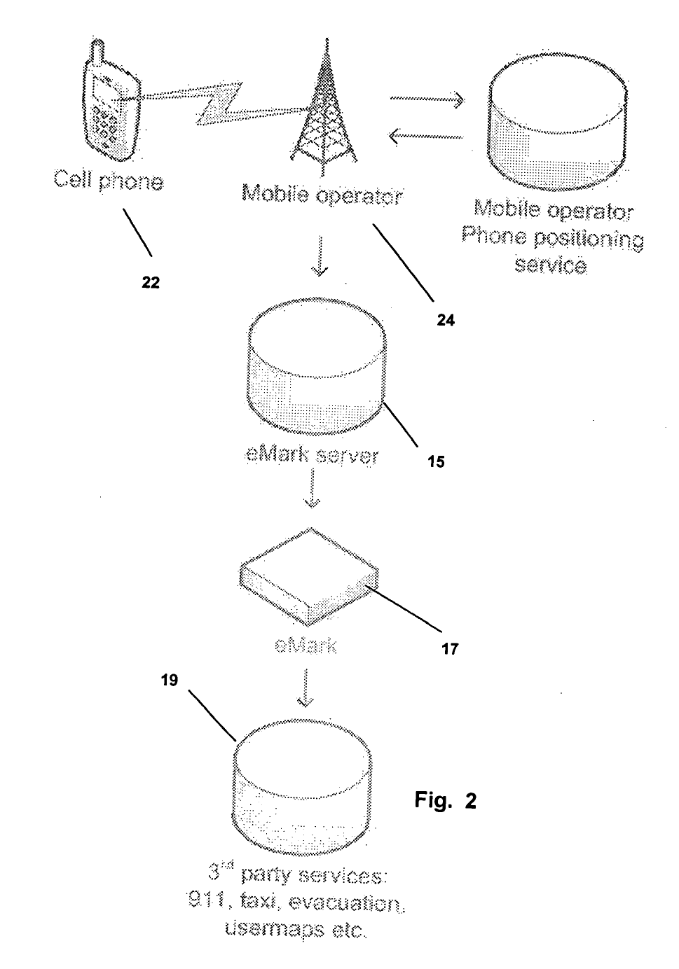

As noted earlier, certain embodiments of the device 10 and method herein are employable without the need for user manual input of data and for temporary use such as a pedestrian requesting a cab as shown in FIG. 2. Of course those skilled in the art will realize that other non-manual means for input of data 14 sufficient for creation of a geographic profile may be employed, and all such methods are anticipated.

When used to request a cab or perhaps a pizza delivery, using a means to electronically determine a current physical location of the user such as a GPS or cell tower location enabled cell phone 22, the current location of the user holding the phone 22 is determined already electronically. With solely this location information, transmitted by the phone 22 or PDA or other location enabled device, a temporary individual designator 17 may be created based on the transmitted coordinates of location. The user, calling through their service provider 24, would contact the cab company or pizza restaurant or other third party 19 service or product provider and request their services or products be delivered to his current location. Using the location information from the phone 22 or other electronic device being used, the cab or other company would communicate the electronic location information to the server 15 using software and/or hardware for the purpose. The server would read the communicated electronic location and convert it to an address or geographic location suitable to the third party the user wishes to provide services and communicate and create a temporary individual designator. The cab company could then contact a cab and transmit the individual designator allowing the driver to use it to communicate with the server 15 and determine where the user is located for pick up.

This temporary creation of a user-specific designator can be accomplished in varying modes of operation with the overriding factor being that the user need only call or contact the supplier with an electronic device that has the capability to determine its location and transmit it. This alleviates the need for manual input by the user and rightfully so since the designator being created is solely for temporary identification of the user's location for the provision of services by a third party with the user specific designator such as a cab driver or delivery service or relative or friend trying to find the user.

Although the invention has been herein disclosed and described with respect to particular embodiments thereof, it should be realized that various changes and modifications may be made therein without departing from the spirit and scope of the invention. While the invention as shown in the drawings and described in detail herein discloses arrangements of elements of particular construction and configuration for illustrating preferred embodiments of structure and method of operation of the present invention, it is to be understood, however, that elements of different construction and configuration and other arrangements thereof, other than those illustrated and described, may be employed in accordance with the spirit of this invention. Any and all such changes, alternations and modifications, as would occur to those skilled in the art, are considered to be within the scope of this invention as broadly defined in the appended claims.

Further, the purpose of the attached abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

What is claimed is:

1. A method of creating, storing and transmitting geographic location information and/or personal information in a central database, the database being accessible via a communication network and being capable of accommodating a plurality of user-specific geographic location profiles, wherein each user-specific geographic location profile corresponds to a user-specific individual designator, the method comprising the steps of:
receiving, at the central database, from a user, user-specific geographic profile information via the communication network;
creating a user-specific geographic profile within the database, the geographic profile at least in part, including the received user-specific geographic profile information;
for each respective user-specific geographic profile, creating a unique user-specific designator which relates only to said respective user specific geographic profile;
communicating said user specific designator relating to their respective geographic profile, to each said user; allowing said user to communicate their respective user specific designator to third parties; and
communicating said user-specific geographic profile relating to said respective specific designator in a response, to any of said third parties who communicate said respective specific designator, to said central database, whereby respective users may communicate their user-specific designator to said their parties in leu of address or contact information and said third parties may access said central database and receive said address or contact information of said user based on said user-specific designator.

2. The method of claim 1 wherein said geographic profile includes a user-specific address input by said user.

3. The method of claim 1 additionally comprising the step of:
digitally signing said user-specific designator.

4. The method of claim 2 additionally comprising the step of:
digitally signing said user-specific designator.

5. The method of claim 1 including the steps of:
said database cross referencing said user-specific address with map coordinates and mapping software to determine map point for said user-specific address; and
communicating said map point in said response communicated to said third parties, whereby said third parties may employ said map point to ascertain the location of said user specific address on a map.

6. The method of claim 2 including the steps of:
said database cross referencing said user-specific address with map coordinates and mapping software to determine map point for said user-specific address; and
communicating said map point in said response communicated to said third parties, whereby said third parties may employ said map point to ascertain the location of said user specific address on a map.

7. The method of claim 3 including the steps of:
said database cross referencing said user-specific address with map coordinates and mapping software to determine map point for said user-specific address; and
communicating said map point in said response communicated to said third parties, whereby said third parties may employ said map point to ascertain the location of said user specific address on a map.

8. The method of claim 4 including the steps of:
said database cross referencing said user-specific address with map coordinates and mapping software to determine map point for said user-specific address; and
communicating said map point in said response communicated to said third parties, whereby said third parties may employ said map point to ascertain the location of said user specific address on a map.

9. The method of claim 1 wherein said third parties include both a seller of a product or service and a delivery service for said seller, whereby either of said seller or said delivery service may determine said user-specific address by communication with said database of said user-specific designator thereby eliminating a first communication of said user-specific address to said seller from said user, and eliminating a second communication of said user-specific address from said seller to said delivery service.

10. The method of claim 2 wherein said third parties include both a seller of a product or service and a delivery service for said seller, whereby either of said seller or said delivery service may determine said user-specific address by communication with said database of said user-specific designator thereby eliminating a first communication of said user-specific address to said seller from said user, and eliminating a second communication of said user-specific address from said seller to said delivery service.

11. The method of claim 3 wherein said third parties include both a seller of a product or service and a delivery service for said seller, whereby either of said seller or said delivery service may determine said user-specific address by communication with said database of said user-specific designator thereby eliminating a first communication of said user-specific address to said seller from said user, and eliminating a second communication of said user-specific address from said seller to said delivery service.

12. The method of claim 4 wherein said third parties include both a seller of a product or service and a delivery service for said seller, whereby either of said seller or said delivery service may determine said user-specific address by communication with said database of said user-specific designator thereby eliminating a first communication of said user-specific address to said seller from said user, and eliminating a second communication of said user-specific address from said seller to said delivery service and eliminating the need for said delivery service to ascertain said user-specific address on a map.

13. A method of temporarily storing and transmitting geographic location information and/or personal information in a central database, the database being accessible via a communication network and being capable of accommodating a plurality of temporary user-specific geographic location profiles, wherein each user-specific geographic location profile corresponds to a user-specific individual designator, the method comprising the steps of:
communicating to the central database, from a user requiring third party assistance, user-specific GPS location information via the communication network;
creating a temporary user-specific geographic profile within the database, the geographic profile at least in part, including the received user-specific GPS current user location information;
for each respective user-specific geographic profile, creating a unique user-specific designator which relates only to said respective temporary user specific geographic profile;
communicating said user specific designator relating to their respective geographic profile, to said third party providing said third party assistance;
allowing said third party to communicate said user specific designator to said database;
communicating said temporary user-specific geographic profile, relating to said respective specific designator, in a response, to said third party communicating said respective specific designator to said central database, whereby said third party can determine the location of said user from information communicated in said temporary user-specific profile; and
deleting said temporary user-specific profile after a determined period of time.

14. The method of claim 13 additionally wherein said third party is a taxi or limousine and said user communicates with said central database using a GPS enabled cell phone which transmits their location to said database.

15. The method of claim 2 additionally including the step of:
publishing said user-specific designator in a telephone directory or advertisement for communication of said user-specific designator to said third party.

16. The method of claim 1 additionally including the step of:
converting communications to said user and to said third parties to their respective language.

17. A data processing system for storing and transmitting a unique identifier of a user's specific geographic location information and/or personal information to third parties in a universally readable format comprising:
computer processor means for processing data and hosting operating software;
storage means for storing said data in a central database;
said database being accessible via a communication network;
first software means for input of user geographic location data by a user, and creation of a user profile relating to said user geographic location data;
means to communicate said user profile to said computer processor;
second software means to create a location designator based on said user profile communicated to said computer processor, and communicate said location designator to said and store said location designator on said central database;
third software means for third parties to communicate with said central database and transmit a communicated location designator provided by a user;
fourth software means to receive said communicated location designator and provide said third parties with said geographic location data relating to said location designator provided by said user, where by a user may create said location designator and thereafter provide it to third parties to identify a specific geographic location for provision of products or services by said third party without having to provide said third party address information.

18. The data processing system of claim 17 additionally comprising:
fifth software means to determine the desired language of said third party and thereafter provide said geographic location data in said desired language.
